(19) United States
(12) Patent Application Publication
(10) Pub. No.: US 2011/0229063 A1
(43) Pub. Date: Sep. 22, 2011

(54) Super air permeability and reinforced seams of peanuts bag (APC BAG-SBA)

(76) Inventor: Jianyi Sun, Duluth, GA (US)

(21) Appl. No.: 11/825,172

(22) Filed: Jul. 5, 2007

(51) Int. Cl. B65D 33/02; B31B 19/00

(52) U.S. Cl. 383/119; 493/186

(57) ABSTRACT

All bulk bags (FIBC) are formed by U-Panel and Side Panels (if bag is circular design we use Main Body instead of U-Panel and Side Panels), Top and Discharge Spouts, Top Panel and Lifting Loops (Drawing 1/6). On this invention, I used the monofilament fabric instead of normal woven fabric as Top Panel to provide super air permeability. Research has proven that moisture (steam) moves from the bottom up, so the Top Panel will has to function for the moisture to escape. The top fabric being constructed with super air permeability will make the entire bag perform with the breath ability.

This invention provides an improved (FIBC) bulk bag used for packaging purposes, more particularly by commercial industries. This invention solves the contamination problems, help keep the ventilation functioning and reinforced seams that are stronger than normal on (FIBC) Bulk Bag.

### BACKGROUND OF THE INVENTION

FIBCs stand for Flexible Intermediate Bulk Containers, “so-called bulk bags.” This kind of packaging has been invented for over 20 years. Manufacturers have adopted different materials and fabrics to make this kind of packaging to perform different functions. The most common bulk bag is made by polypropylene fabric with flat yarns interwoven method. (FIG. 6)

Some industries need their packaging to be ventilated, they have tried to adjust alliance of flat yarns to keep regular gaps between yarns in order to create a ventilated bag (FIG. 7). Although, it seems that a ventilated bag have been made, but side effect of using polypropylene fabric with flat yarns interwoven method created problem of contamination . Dust can fall and settle through the gaps of fabric, other particles and bugs can go through the gaps between the yarns and cause contamination problem.

The American Peanut Council (APC) has designed a special bag for peanuts in the year 2004 referred to as APC tote bag. In the same year APC Tote Bag Council was created to regulate and improve the APC Tote Bag. The Council has set the standard for air permeability to the minimum 20 cfm for top fabric. Currently in the Flexible Intermediate Bulk Container (FIBC) industry, companies only have one method to produce the woven fabric with the minimum air permeability. The method is to weave the flat yarns sparsely in order to keep space between the yarns. Using this method to construct the bags meet the American Peanut Council standards, however it has unsolvable problems. Dust falling and settling through the gaps of the APC bags. Particles and bugs going through the gaps between the yarns can contaminate the peanuts; bugs can easily lay eggs on the top of the bags which will contaminate the peanuts. Current woven methods will not solve the problems of contamination because the method lacks the ability to provide more air permeability within the bag. In order to increase more air permeability, companies have tried using larger gaps in the weave but had little success.

### BRIEF DESCRIPTION OF EACH FIGURE

FIG. 1: The construction of bulk bag (APC Bag or FIBC).

FIG. 2: Reinforced fold and stitching method for APC Bag.

FIG. 3: Normal fold and stitching method of bulk bag.

FIG. 4: Reinforced fold and stitching method for APC Bag.

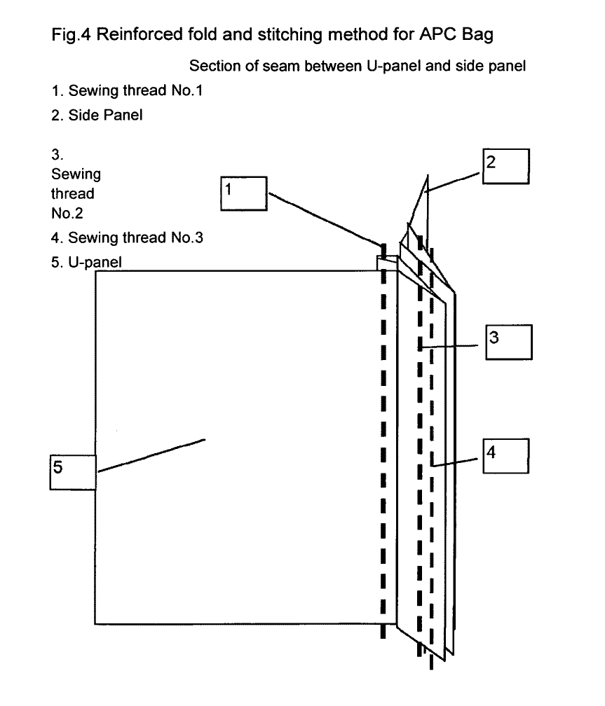

FIG. 5: The construction of monofilament fabric.

FIG. 6: The construction of normal woven fabric.

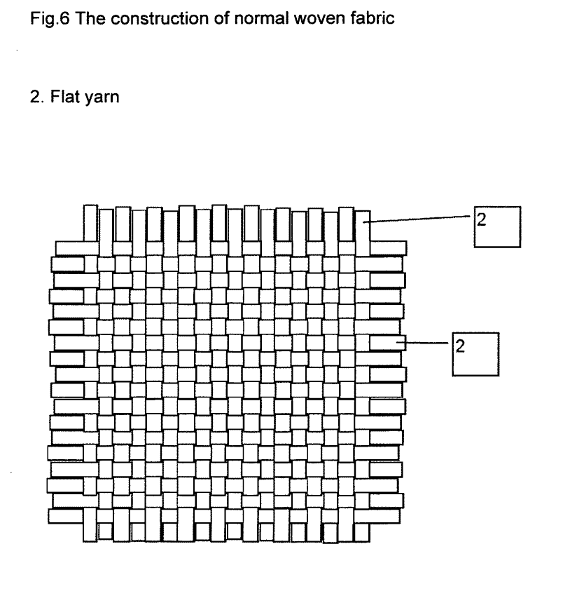

FIG. 7: The construction of normal woven fabric with gaps.

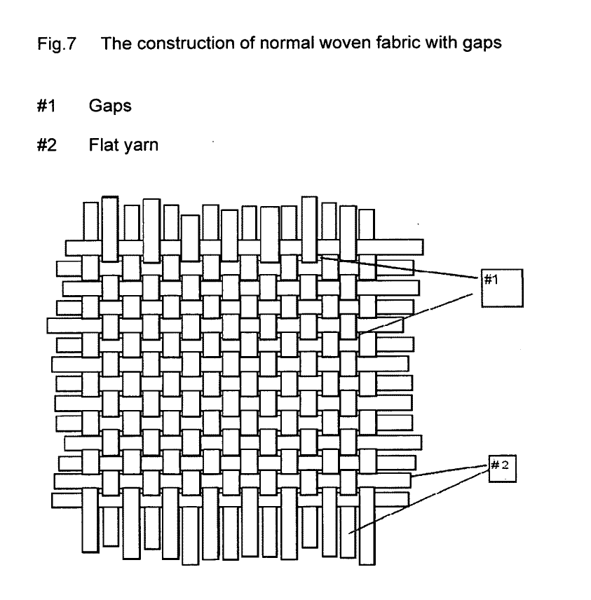

### DEFINITION OF SOME KEY WORDS

APC Bag: a kind of bag that can hold 2400 lbs. of redskin or blanched kernels, or 2200 lbs. of split kernels, or 1000 lbs. of inshell peanuts.

(FIBC) Bulk Bag: Flexible Intermediate Bulk Container

Small Woven Bag: This bag made by Polypropylene or Polyethylene, using interwoven method. This bag can hold 25 lbs. to 100 lbs.

Yarn: The same meaning as strap.

1. After further research I have created and claim the process for increasing more air permeability in the FIBC bulk bags comprising of a fabric called monofilament. I have discovered that monofilament fabric has the unique feature for super (higher) air permeability along with a tighter weave. As of today, monofilament fabric is only used in the GEO-textile industries; no one has ever thought that this fabric could be applied to the FIBC Industry.

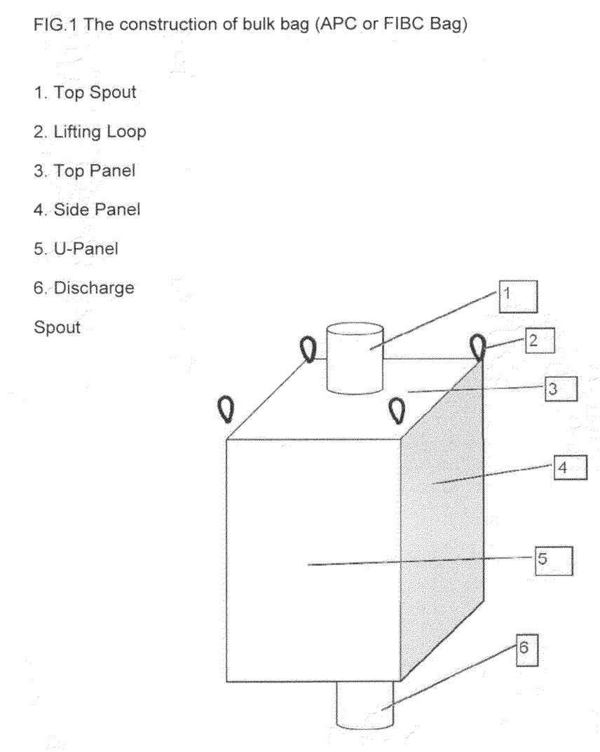

2. In 2007, I invented a bag called BAG-SBA to solve contamination problems and to keep the ventilation functioning at all time. This bag is made by monofilament fabric partially. My clients especially in the Peanut Industry have great success using my bag and widely accepted by the FIBC industry. I haven't seen any bag made by monofilament fabric completely or partially before my invention. Because all FIBC bulk bags are formed by U-Panel and Side Panels (if the bag is circular in design we used Main Body instead of U-Panel and Side Panels), Top and Discharge Spouts, Top Panel and Lifting Loops (FIG. 1). According to claim 1, I have used the monofilament fabric instead of normal woven fabric as the Top Panel to provide super air permeability.
Research has proven that moisture (steam) moves from the bottom to top, so the Top Panel has to function for the moisture to escape.

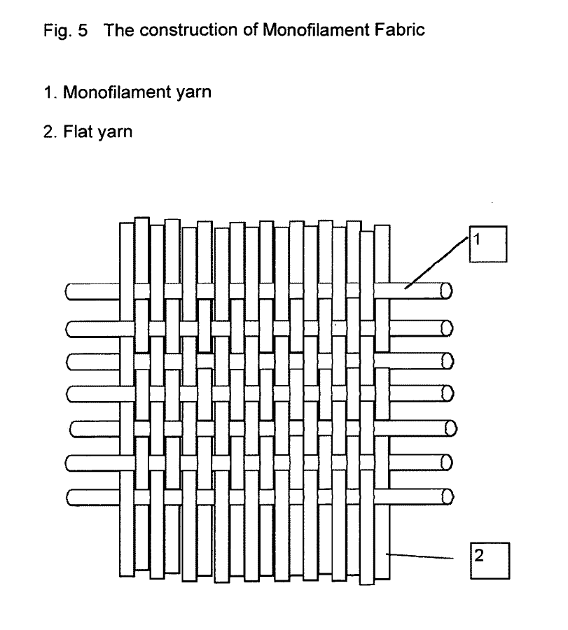

3. The method according to claim 1, the top fabric is then constructed with super air permeability that will make the entire bag perform with the breath ability. The monofilament fabric (FIG. 5) is made by monofilament yarns (#A) and flat yarns (#B). According to the drawing the flat yarns located at machine direction (MD) and monofilament yarns located at cross machine direction (XD). The configuration show that no matter what the direction the yards are in the fabric is still interwoven by monofilament yarns and flat yarns together, the fabric will be named Monofilament Fabric.
When the monofilament fabric is woven slightly tight, it doesn't appear to have any gaps when exam from 90° angle. The gaps appeared only when exam the weave (fabric) from a 45° angle. This feature will keep out dust land and going through the fabric, but still be able to keep the fabric ventilated.

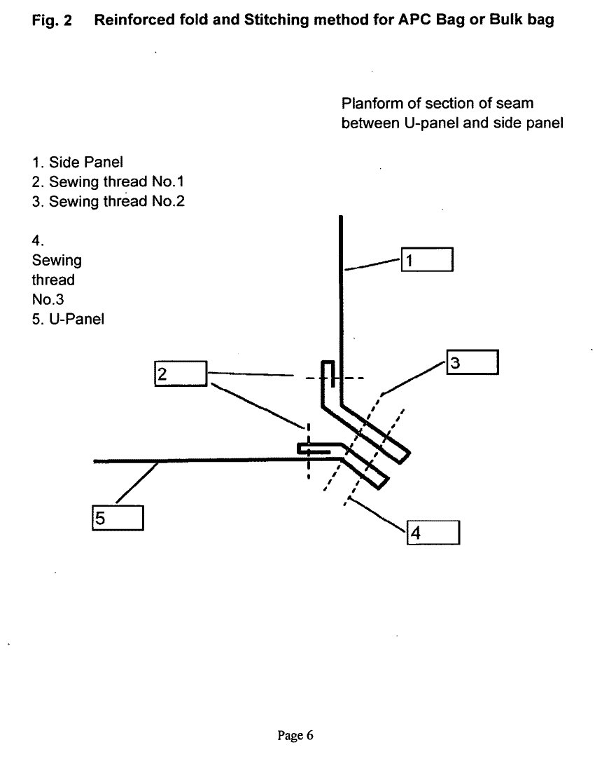

4. The reinforced seams used to stitch the bulk bag in claim 2 were independently designed at our test lab, not a requirement by The American Peanut Council. I designed the seams between U-Panel and Side Panels all which to be double folded along with special stitching (FIG. 2). As described by (FIG. 2) both of the edges of U-Panel and Side Panels have been double folded, and the raw edges have been folded inside and stitched invisibly.

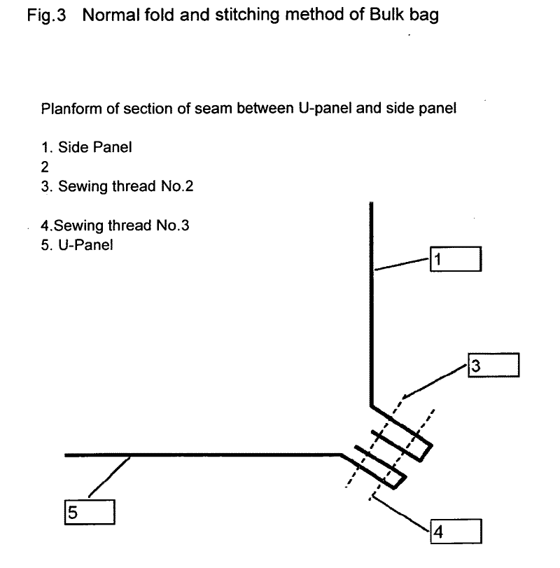

5. The method according to claim 3; will provide two distinct advantages for the newly designed FIBC tote bag. First this method will prevent loose fibers from falling inside the bag. Second the junctions will have the double connective strength making the bag stronger than normal design (FIG. 3).

6. The method according to claim 4, the sewing thread No.1 (FIG. 2) is very important in this invention because without it the edges of the panel will not join together and have the advantages of double connective strength. We designed the double fold for the edges, the width of first fold is 1.5″ to 5″, and the width of second fold is 0.5″ to 4″.

7. According to claim 1 and claim 2, monofilament fabric are use on FIBC Bulk Bag and small woven bag. Whatever the bag design may be, others cannot use the monofilament fabric as the top fabric, spouts fabric, and body fabric of bulk bag (FIBC). Also others cannot use the monofilament as the body of small woven bag. I am the first one to use the monofilament in the packaging industry. I claim the exclusive right to use the monofilament fabric for packaging material.

8. According to claim 3 and claim 4, reinforced fold and stitching method for APC Bag. I claim the width between 1.5″ to 5″ double or single fold of main body seams (or the seams between U-Panel and Side Panels) and sewn edge onto main body of fabric applied to the APC Bag.
